(19) United States
(12) Patent Application Publication
(10) Pub. No.: US 2025/0385045 A1
(43) Pub. Date: Dec. 18, 2025

(54) MULTILAYER CERAMIC CAPACITOR

(71) Applicant: Murata Manufacturing Co., Ltd., Nagaokakyo-shi (JP)

(72) Inventor: Eisuke SHIMOMURA, Nagaokakyo-shi (JP)

(21) Appl. No.: 19/234,670

(22) Filed: Jun. 11, 2025

(30) Foreign Application Priority Data
Jun. 18, 2024 (JP) 2024-097916

(51) Int. Cl. H01G 4/12; H01G 4/008; H01G 4/224; H01G 4/30

(52) U.S. Cl. CPC H01G 4/1209; H01G 4/0085; H01G 4/224; H01G 4/30

(57) ABSTRACT

In a multilayer ceramic capacitor, in a cross section of a multilayer body in a plane parallel or substantially parallel to a width direction and a height direction, an effective layer portion includes a first region defined by four corner portions of the effective layer portion, and a second region defined as a region of the effective layer portion excluding the first region, segregation amounts of manganese and magnesium in the first region are larger than segregation amounts of manganese and magnesium in the second region, and portions of internal electrode layers in the first region includes insulating portions.

### CROSS REFERENCE TO RELATED APPLICATIONS

This application claims the benefit of priority to Japanese Patent Application No. 2024-097916 filed on Jun. 18, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

For example, the multilayer ceramic capacitor described in Japanese Unexamined Patent Application, Publication No. 2001-237137 includes a capacitor main body including a ceramic sintered body made of a dielectric such as barium titanate. Internal electrode layers, each made of a noble metal material such as silver or a silver-palladium alloy or a base metal material such as nickel, are provided inside the capacitor body with a corresponding one of the ceramic layers functioning as dielectric layers interposed therebetween. The internal electrode layers alternately extend toward one end surface and the other end surface of the capacitor main body. The internal electrode layers extending toward the one end surface and the internal electrode layers extending toward the other end surface which are alternately provided are electrically connected to external electrodes having different potentials.

The internal electrode layers of the multilayer capacitor described in Japanese Unexamined Patent Application, Publication No. 2001-237137 are made of a metal material, and the external electrodes are made of a glass component and a plurality of metal components including a metal that can be the same as or alloyed with the metal material. The external electrodes are bonded to the wiring board via an electrically conductive resin adhesive. The area occupancy of the metal component with respect to the cross-sectional area of each of the external electrodes ranges from 60% to 95%. This makes it possible for the multilayer capacitor described in Japanese Unexamined Patent Application, Publication No. 2001-237137 to be mounted on a wiring board at low cost with high reliability, without using solder.

In the above-described general multilayer ceramic capacitor, the thicknesses of the dielectric layers and the thicknesses of the internal electrode layers in the vicinity of the corner portions of the multilayer ceramic capacitor may be reduced. When the thicknesses of the dielectric layers or the thicknesses of the internal electrode layers are reduced, the high-temperature load reliability tends to decrease, starting from the portions with reduced thicknesses. As described above, in the conventional multilayer ceramic capacitors, the high-temperature load reliability tends to decrease.

### SUMMARY OF THE INVENTION

Example embodiments of the present invention provide multilayer ceramic capacitors in each of which a decline in high-temperature load reliability is reduced or prevented.

A multilayer ceramic capacitor according to an example embodiment of the present invention includes a multilayer body including a plurality of dielectric layers and a plurality of internal electrode layers that are laminated, a first main surface and a second main surface opposed to each other in a height direction, a first lateral surface and a second lateral surface opposed to each other in a width direction orthogonal or substantially orthogonal to the height direction, a first end surface and a second end surface opposed to each other in a length direction orthogonal or substantially orthogonal to the height direction and the width direction, an effective layer portion in which the plurality of dielectric layers and the plurality of internal electrode layers are alternately laminated, and outer layer portions that sandwich the effective layer portion by a corresponding one of the outer layer portions adjacent to the first main surface and a corresponding one of the outer layer portions adjacent to the second main surface, a first external electrode on the first end surface, and a second external electrode on the second end surface, in which, in a cross section of the multilayer body in a plane parallel or substantially parallel to the width direction and the height direction, the effective layer portion includes a first region defined by four corner portions of the effective layer portion and a second region defined as a region of the effective layer portion excluding the first region, segregation amounts of manganese and magnesium in the first region are larger than segregation amounts of manganese and magnesium in the second region, and portions of the internal electrode layers in the first region include insulating portions.

According to example embodiments of the present invention, it is possible to provide multilayer ceramic capacitors in each of which a decline in high-temperature load reliability is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor according to an example embodiment of the present invention.

FIG. 2 is a cross-sectional view taken along the line 101-101 in FIG. 1.

FIG. 3 is a cross-sectional view taken along the line 102-102 in FIG. 2.

FIG. 4 is a cross-sectional view taken along the line 103-103 in FIG. 2.

FIG. 5 is a cross-sectional view taken along the line 104-104 in FIG. 2.

FIG. 6 is a cross-sectional view taken along the line 105-105 in FIG. 2.

FIG. 7 shows the results of elemental analysis of a multilayer ceramic capacitor according to a present example embodiment of the present invention.

FIG. 8 shows the results of elemental analysis of a multilayer ceramic capacitor according to a present example embodiment of the present invention.

FIG. 9 is a table showing Examples of a multilayer ceramic capacitor according to a present example embodiment of the present invention.

FIG. 10 is a view showing a side gap base body and a side gap sheet.

FIG. 11 is a view showing a multilayer chip in which a side gap sheet is laminated on a side gap base body.

### DETAILED DESCRIPTION OF THE EXAMPLE EMBODIMENTS

Example embodiments of the present invention will be described in detail below with reference to the drawings.

### Multilayer Ceramic Capacitor

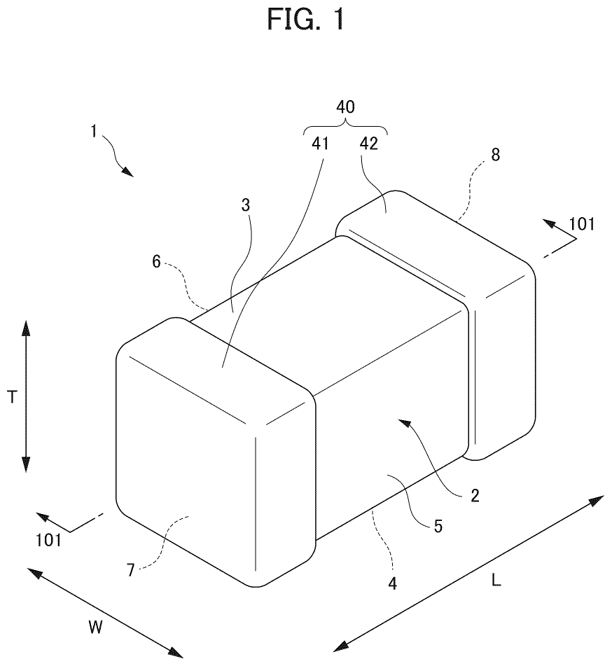

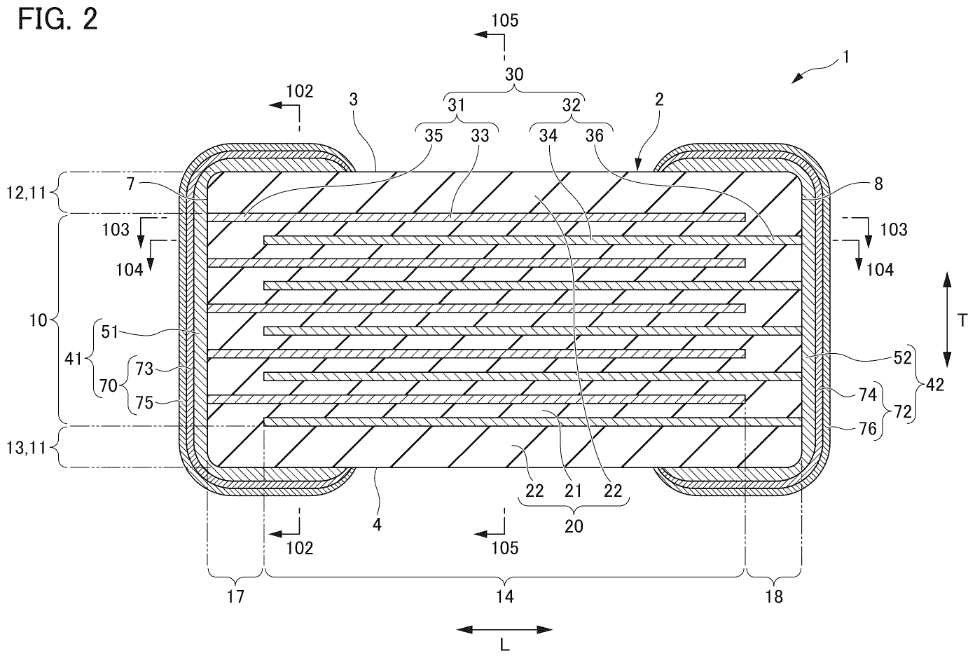

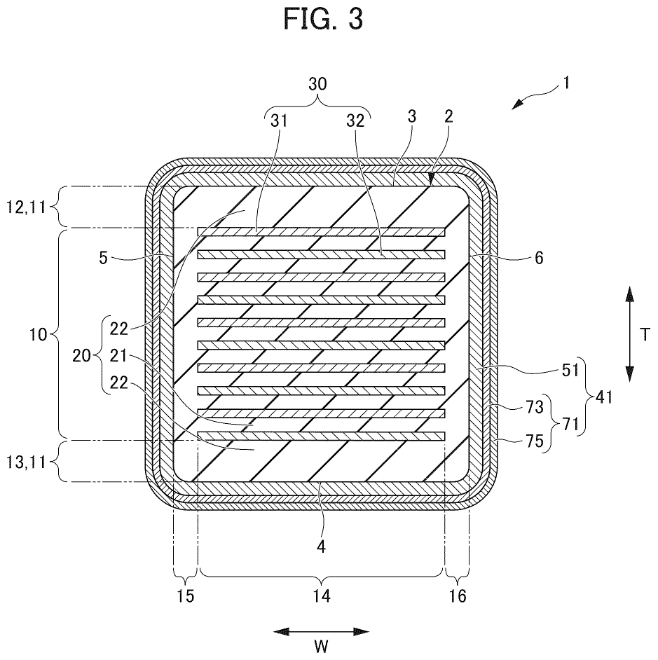

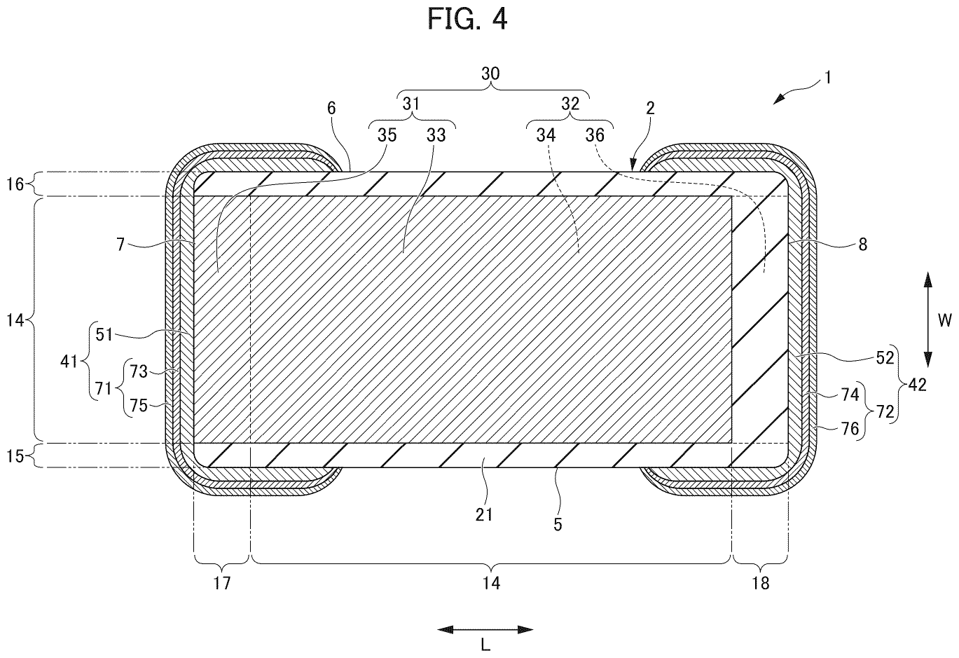

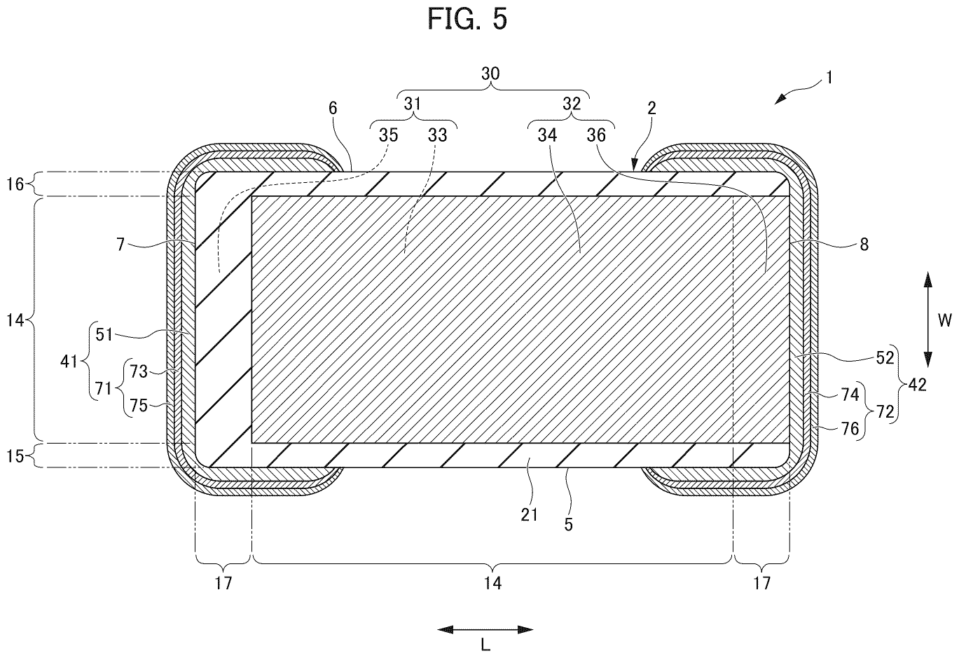

A multilayer ceramic capacitor 1 according to an example embodiment of the present invention will be described with reference to the drawings. FIG. 1 is an external perspective view of a multilayer ceramic capacitor 1 according to an example embodiment of the present invention. FIG. 2 is a cross-sectional view taken along the line 101-101 in FIG. 1. FIG. 3 is a cross-sectional view taken along the line 102-102 in FIG. 2. FIG. 4 is a cross-sectional view taken along the line 103-103 in FIG. 2. FIG. 5 is a cross-sectional view taken along the line 104-104 in FIG. 2.

As shown in FIG. 1, the multilayer ceramic capacitor 1 has a rectangular or substantially rectangular parallelepiped shape. The multilayer ceramic capacitor 1 includes a multilayer body 2 having a rectangular or substantially rectangular parallelepiped shape and a pair of external electrodes 40 provided at both ends of the multilayer body 2 so as to be separated from each other.

In FIG. 1, the arrow T indicates a height direction of the multilayer ceramic capacitor 1 and the multilayer body 2. The height direction T is also referred to as a thickness direction or a lamination direction of the multilayer ceramic capacitor 1 and the multilayer body 2. In FIG. 1, the arrow L indicates a length direction orthogonal or substantially orthogonal to the height direction T of the multilayer ceramic capacitor 1 and the multilayer body 2. In FIG. 1, the arrow W indicates a width direction orthogonal or substantially orthogonal to the height direction T and the length direction L of the multilayer ceramic capacitor 1 and the multilayer body 2. The pair of external electrodes 40 are respectively provided at one end portion and the other end portion in the length direction L of the multilayer body 2.

The cross section shown in FIG. 2 is referred to as an LT cross section. The cross section shown in FIG. 3 is referred to as a WT cross section. The cross section shown in FIG. 4 and the cross section shown in FIG. 5 are referred to as LW cross sections.

### Multilayer Body

The two surfaces opposed to each other in the height direction T of the multilayer body 2 are referred to as a first main surface 3 and a second main surface 4. The two surfaces opposed to each other in the length direction L orthogonal or substantially orthogonal to the height direction T of the multilayer body are referred to as a first end surface 7 and a second end surface 8. The two surfaces opposed to each other in the width direction W orthogonal or substantially orthogonal to the height direction T and the length direction L of the multilayer body 2 are referred to as a first lateral surface 5 and a second lateral surface 6.

As shown in FIG. 1, the multilayer body 2 has a rectangular or substantially rectangular parallelepiped shape. The length of the multilayer body 2 in the length direction L may not be longer than the length in the width direction W. The shapes of the corner portions of the multilayer body 2 and the ridge portions of the multilayer body 2 are preferably rounded. Each of the corner portions is a portion where the three surfaces of the multilayer body intersect with each other. Each of the ridge portions is a portion where the two surfaces of the multilayer body 2 intersect with each other. A portion or the whole of the surface constituting the multilayer body 2 may include unevenness or the like.

The size of the multilayer body 2 is not limited. A preferred length of the multilayer body 2 in the length direction L is, for example, about 0.2 mm or more and about 6 mm or less. A preferred length of the multilayer body 2 in the height direction T is, for example, about 0.05 mm or more and about 5 mm or less. A preferred length of the multilayer body 2 in the width direction W is, for example, about 0.1 mm or more and about 5 mm or less.

### Division in Height Direction

As shown in FIGS. 2 and 3, the multilayer body 2 is divided in the height direction T into an inner layer portion 10 and main surface-side outer layer portions 11. The main surface-side outer layer portions 11 include a first main surface-side outer layer portion 12 and a second main surface-side outer layer portion 13. The first main surface-side outer layer portion 12 and the second main surface-side outer layer portion 13 are located at positions sandwiching the inner layer portion 10 in the height direction T. That is, the multilayer body 2 is divided into the first main surface-side outer layer portion 12, the inner layer portion 10, and the second main surface-side outer layer portion 13.

### Dielectric Layer

The inner layer portion 10 includes a plurality of dielectric layers 20 and a plurality of internal electrode layers 30 alternately laminated in the height direction T. The inner layer portion 10 includes the plurality of internal electrode layers including from an internal electrode layer 30 located closest to the first main surface 3 to an internal electrode layer 30 located closest to the second main surface 4 in the height direction T. In the inner layer portion 10, the plurality of internal electrode layers 30 are opposed to each other with a corresponding one of the dielectric layers 20 interposed therebetween. The inner layer portion 10 is a portion that generates capacitance and substantially defines and functions as a capacitor. The dielectric layers 20 included in the inner layer portion 10 are referred to as inner dielectric layers 21. The dielectric layer 20 included in the first main surface-side outer layer portion 12 and the dielectric layer 20 included in the second main surface-side outer layer portion 13 are each referred to as an outer dielectric layer 22.

The dielectric layers 20 are each made of a dielectric material. Examples of the dielectric material include dielectric ceramics including components such as barium titanate, calcium titanate, strontium titanate or calcium zirconate. The dielectric material may be obtained by adding an auxiliary component such as, for example, a manganese compound, an iron compound, a copper compound, a cobalt compound, or a nickel compound to these main components. A preferable material of the dielectric material is, for example, a material including barium titanate as a main component.

Each of the dielectric layers 20 preferably has a thickness of, for example, about 0.2 μm or more and about 10 μm or less. The number of layers of the laminated dielectric layer 20 is, for example, preferably 15 or more and 1200 or less. The number of layers of the dielectric layer 20 is the sum of the number of layers of the inner dielectric layers 21 and the number of layers of the outer dielectric layers 22.

### Internal Electrode Layer

The plurality of internal electrode layers 30 include a plurality of first internal electrode layers 31 and a plurality of second internal electrode layers 32. The first internal electrode layer 31 and the second internal electrode layer 32 are alternately provided in the height direction T with a corresponding one of the dielectric layers 20 interposed therebetween. The first internal electrode layers 31 extend toward the first end surface 7. The second internal electrode layers 32 extend toward the second end surface 8.

As shown in FIG. 4, each of the first internal electrode layers 31 is divided into a first counter portion 33 and a first extension portion 35. The first counter portion 33 is a portion opposed to the second internal electrode layer 32 with a corresponding one of the dielectric layers 20 interposed therebetween. The first extension portion 35 is a portion extending from the first counter portion 33 toward the first end surface 7. The first extension portion 35 is exposed at the first end surface 7.

As shown in FIG. 5, each of the second internal electrode layers 32 is divided into a second counter portion 34 and a second extension portion 36. The second counter portion 34 is a portion opposed to the first internal electrode layer 31 with a corresponding one of the dielectric layers 20 interposed therebetween. The second extension portion 36 is a portion extending from the second counter portion 34 toward the second end surface 8. The second extension portion 36 is exposed at the second end surface 8.

In the multilayer ceramic capacitor 1, the first counter portion 33 and the second counter portion 34 are opposed to each other with a corresponding one of the dielectric layers 20 interposed therebetween, so that capacitance is generated. As a result, the multilayer ceramic capacitor 1 provides capacitor characteristics.

The shapes of the first counter portion 33 and the second counter portion 34 are not limited. A preferable shape of each of the first counter portion 33 and the second counter portion 34 is, for example, a rectangular or substantially rectangular shape. Similarly, the shapes of the first extension portion 35 and the second extension portion 36 are not limited. A preferable shape of each of the first extension portion 35 and the second extension portion 36 is, for example, a rectangular or substantially rectangular shape. In the rectangular or substantially rectangular shape described above, the shape of each of the rectangular corner portions may be a rounded shape. The shape of each of the rectangular or substantially rectangular corner portions may be an oblique shape.

The length of the first counter portion 33 in the width direction W and the length of the first extension portion 35 in the width direction W may be the same or substantially the same. One of the length of the first counter portion 33 in the width direction W or the length of the first extension portion 35 in the width direction W may be shorter. The length of the second counter portion 34 in the width direction w and the length of the second extension portion 36 in the width direction W may be the same or substantially the same. One of the length of the second counter portion 34 in the width direction W or the length of the second extension portion 36 in the width direction W may be shorter.

Examples of the material of the first internal electrode layer 31 and the second internal electrode layer 32 include electrically conductive materials such as metals such as nickel, copper, silver, palladium, or gold, or alloys including at least one of these metals. When an alloy is used, an example of the material of the first internal electrode layer 31 and the second internal electrode layer 32 is an alloy of silver and palladium.

An example of a preferred thickness of each of the first internal electrode layer 31 and the second internal electrode layer 32 is, for example, about 0.2 μm or more and about 2.0 μm or less. A preferred number of layers of the sum of the number of layers of the first internal electrode layer 31 and the number of layers of the second internal electrode layer 32 is, for example, 15 or more and 1000 or less.

### Main Surface-Side Outer Layer Portion

As shown in FIGS. 2 and 3, a portion including an aggregate of the plurality of dielectric layers 20 located between the first main surface 3 and the internal electrode layer 30 closest to the first main surface 3 is referred to as a first main surface-side outer layer portion 12. The first main surface-side outer layer portion 12 is located adjacent to the first main surface 3 of the multilayer body 2. A portion including an aggregate of the plurality of dielectric layers 20 located between the second main surface 4 and the internal electrode layer 30 closest to the second main surface 4 is referred to as a second main surface-side outer layer portion 13. The second main surface-side outer layer portion 13 is located adjacent to the second main surface 4 of the multilayer body 2. The dielectric layer 20 used in the first main surface-side outer layer portion 12 and the second main surface-side outer layer portion 13 may be the same as the dielectric layer 20 used in the inner layer portion 10. The material of the inner dielectric layer 21 and the material of the outer dielectric layer 22 may be the same.

### Effective Layer Portion

A portion where the first counter portions 33 of the first internal electrode layers 31 and the second counter portions 34 of the second internal electrode layers 32 are opposed to each other is referred to as an effective layer portion 14. The effective layer portion 14 is a portion in which the dielectric layers 20 and the internal electrode layers 30 are alternately laminated. The effective layer portion 14 is a portion of the inner layer portion 10. FIGS. 4 and 5 each show the range of the effective layer portion 14 in the width direction W and the length direction L. The effective layer portion 14 is a portion of the inner layer portion 10 excluding a side gap described later and an end gap described later. The effective layer portion 14 is also referred to as a capacitance forming portion or a capacitor effective portion.

### Division in W Direction

The multilayer body 2 is divided in the width direction W into a first lateral surface-side outer layer portion 15, an effective layer portion 14, and a second lateral surface-side outer layer portion 16. The first lateral surface-side outer layer portion 15 is a portion that is located between the effective layer portion 14 and the first lateral surface 5, and includes the dielectric layer 20. The second lateral surface-side outer layer portion 16 is a portion that is located between the effective layer portion 14 and the second lateral surface 6, and includes a dielectric layer 20. FIG. 3, FIG. 4, and FIG. 5 show the ranges of the first lateral surface-side outer layer portion 15, the effective layer portion 14, and the second lateral surface-side outer layer portion 16 in the width direction W. The first lateral surface-side outer layer portion 15 and the second lateral surface-side outer layer portion 16 are referred to as a W gap or a side gap.

### Division in L Direction

The multilayer body 2 is divided in the length direction L into the first end surface-side outer layer portion 17, the effective layer portion 14, and the second end surface-side outer layer portion 18. The first end surface-side outer layer portion 17 is a portion including the dielectric layers 20 and the first extension portions 35 located between the effective layer portion 14 and the first end surface 7. The first end surface-side outer layer portion 17 is an aggregate including portions of the plurality of dielectric layers 20 adjacent to the first end surface 7 and the plurality of first extension portions 35. The second end surface-side outer layer portion 18 is a portion including the dielectric layers 20 and the second extension portions 36 located between the effective layer portion 14 and the second end surface 8. The second end surface-side outer layer portion 18 is an aggregate including portions of the plurality of dielectric layers 20 adjacent to the second end surface 8 and the plurality of second extension portions 36. FIGS. 2, 4, and 5 illustrate ranges of the first end surface-side outer layer portion 17, the effective layer portion 14, and the second end surface-side outer layer portion 18 in the length direction L. The first end surface-side outer layer portion 17 and the second end surface-side outer layer portion 18 are referred to as an L gap or an end gap.

### External Electrode

The external electrodes 40 include a first external electrode 41 and a second external electrode 42. The first external electrode 41 is provided adjacent to the first end surface 7 of the multilayer body 2. The second external electrode 42 is provided adjacent to the second end surface 8 of the multilayer body 2.

The basic configurations of the first external electrode 41 and the second external electrode 42 are the same or substantially the same. The first external electrode 41 and the second external electrode 42 have a plane-symmetrical or substantially plane-symmetrical shape with respect to the WT cross section in the middle in the length direction L of the multilayer ceramic capacitor 1.

The first external electrode 41 is provided on the first end surface 7. The first external electrode 41 is in contact with the first extension portion 35 of each of the plurality of first internal electrode layers 31 exposed on the first end surface 7. The first external electrode 41 is electrically connected to the plurality of first internal electrode layers 31. The first external electrode 41 may also be provided on a portion of the first main surface 3 and a portion of the second main surface 4, and a portion of the first lateral surface 5 and a portion of the second lateral surface 6. In the present example embodiment, the first external electrode 41 extends from the first end surface 7 to a portion of the first main surface 3 and a portion of the second main surface 4, and a portion of the first lateral surface 5 and a portion of the second lateral surface 6.

The second external electrode 42 is provided on the second end surface 8. The second external electrode 42 is in contact with the second extension portion 36 of each of the plurality of second internal electrode layers 32 exposed on the second end surface 8. The second external electrode 42 is electrically connected to the plurality of second internal electrode layers 32. The second external electrode 42 may also be provided on a portion of the first main surface 3 and a portion of the second main surface 4, and a portion of the first lateral surface 5 and a portion of the second lateral surface 6. In the present example embodiment, the second external electrode 42 extends from the second end surface 8 to a portion of the first main surface 3 and a portion of the second main surface 4, and a portion of the first lateral surface 5 and a portion of the second lateral surface 6.

In the multilayer body 2, the first counter portions 33 of the first internal electrode layers 31 and the second counter portions 34 of the second internal electrode layers 32 are opposed to each other with a corresponding one of the dielectric layers 20 interposed therebetween, thus generating a capacitance. Therefore, the characteristics of the capacitor are provided between the first external electrode 41 to which the first internal electrode layers are connected and the second external electrode 42 to which the second internal electrode layers 32 are connected.

### Base Electrode Layer

As shown in FIGS. 2, 4, and 5, the first external electrode 41 includes a first base electrode layer 51 and a first plated layer 71. The first plated layer 71 is provided on the first base electrode layer 51. The second external electrode 42 includes a second base electrode layer 52 and a second plated layer 72. The second plated layer 72 is provided on the second base electrode layer 52.

The first base electrode layer 51 is provided on the first end surface 7. The first base electrode layer 51 is in contact with the first extension portion 35 of each of the plurality of first internal electrode layers 31 exposed on the first end surface 7. The first base electrode layer 51 extends from the first end surface 7 to a portion of the first main surface 3 and a portion of the second main surface 4, and a portion of the first lateral surface 5 and a portion of the second lateral surface 6.

The second base electrode layer 52 is provided on the second end surface 8. The second base electrode layer 52 is in contact with the second extension portion 36 of each of the plurality of second internal electrode layers 32 exposed at the second end surface 8. The second base electrode layer 52 extends from the second end surface 8 to a portion of the first main surface 3 and a portion of the second main surface 4, and a portion of the first lateral surface 5 and a portion of the second lateral surface 6.

The first base electrode layer 51 and the second base electrode layer 52 are, for example, fired layers. The fired layer preferably includes a metal component. The fired layer preferably includes at least one of a glass component or a ceramic component in addition to the metal component. The metal component includes, for example, at least one of copper, nickel, silver, palladium, an alloy of silver and palladium, gold, or the like. The glass component includes, for example, at least one of boron, silicon, barium, magnesium, aluminum, lithium, or the like. The ceramic component may be a ceramic material of the same type as the dielectric layer 20. The ceramic component may be a ceramic material that is dissimilar to the dielectric layer 20. The ceramic component includes, for example, at least one of barium titanate, calcium titanate, a mixed crystal material in which a portion of the barium in barium titanate is substituted with calcium, strontium titanate, calcium zirconate, or the like.

An example of the fired layer is a layer formed by applying an electrically conductive paste including glass and a metal to a multilayer body, and firing the paste. The fired layer is formed by simultaneously firing a multilayer chip before firing, which is a material of a multilayer body including a plurality of internal electrode layers and a plurality of dielectric layers, and an electrically conductive paste applied to the multilayer chip. Alternatively, the fired layer is formed by firing the multilayer chip to obtain a multilayer body, applying an electrically conductive paste to the multilayer body, and firing the multilayer body. When the electrically conductive paste is fired after the multilayer body is obtained, the fired layer is preferably formed by firing the electrically conductive paste to which a ceramic material is added instead of a glass component. When an electrically conductive paste to which a ceramic material is added is used, the ceramic material to be added is preferably the same type of ceramic material as the dielectric layer. The fired layer may include a plurality of layers.

An example of a preferred thickness of the first base electrode layer 51 on the first end surface 7 in the length direction L is, for example, about 10 μm or more and about 200 μm or less in the middle portion in the height direction T and the width direction W of the first base electrode layer 51.

An example of a preferred thickness of the second base electrode layer 52 on the second end surface 8 in the length direction L is, for example, about 10 μm or more and about 200 μm or less in the middle portion of the second base electrode layer 52 in the height direction T and the width direction W.

In a case where the first base electrode layer 51 is also provided on a portion of at least one of the first main surface 3 or the second main surface 4, an example of a preferred thickness in the height direction T of the first base electrode layer 51 provided in this portion is, for example, about 3 μm or more and about 40 μm or less in the middle portion in the length direction L and the width direction W of the first base electrode layer 51 provided in this portion.

In a case where the first base electrode layer 51 is also provided on a portion of at least one of the first lateral surface 5 and the second lateral surface 6, an example of a preferred thickness in the width direction W of the first base electrode layer 51 provided in this portion is, for example, about 3 μm or more and about 40 μm or less in the middle portion in the length direction L and the height direction T of the first base electrode layer 51 provided in this portion.

In a case where the second base electrode layer 52 is also provided on a portion of at least one of the first main surface 3 or the second main surface 4, an example of a preferred thickness in the height direction T of the second base electrode layer 52 provided in this portion is, for example, about 3 μm or more and about 40 μm or less in the middle portion in the length direction L and the width direction W of the second base electrode layer 52 provided in this portion.

In a case where the second base electrode layer 52 is also provided on a portion of at least one of the first lateral surface 5 or the second lateral surface 6, an example of a preferred thickness in the width direction W of the second base electrode layer 52 provided in this portion is, for example, about 3 μm or more and about 40 μm or less in the middle portion in the length direction L and the height direction T of the second base electrode layer 52 provided in this portion.

The first plated layer 71 covers the first base electrode layer 51. The second plated layer 72 covers the second base electrode layer 52.

The first plated layer 71 and the second plated layer 72 may include, for example, at least one of copper, nickel, tin, silver, palladium, an alloy of silver and palladium, gold, or the like. Each of the first plated layer 71 and the second plated layer 72 may include a plurality of layers. A preferred configuration of the first plated layer 71 and the second plated layer 72 is, for example, a two-layer configuration in which a tin plated layer is provided on a nickel plated layer.

The first plated layer 71 covers the first base electrode layer 51. In the present example embodiment, the first plated layer 71 includes, for example, a first nickel plated layer 73 and a first tin plated layer 75. The first tin plated layer 75 is located on the first nickel plated layer 73.

The second plated layer 72 covers the second base electrode layer 52. In the present example embodiment, the second plated layer 72 includes, for example, a second nickel plated layer 74 and a second tin plated layer 76. The second tin plated layer 76 is located on the second nickel plated layer 74.

The nickel plated layer reduces or prevents the erosion of the first base electrode layer 51 and the second base electrode layer 52 by solder when the multilayer ceramic capacitor 1 is mounted. The tin plated layer improves solder wettability when the multilayer ceramic capacitor 1 is mounted. The tin plated layer facilitates mounting of the multilayer ceramic capacitor 1. A preferred thickness of each of the first nickel plated layer 73, the first tin plated layer 75, the second nickel plated layer 74, and the second tin plated layer 76 is, for example, about 2 μm or more and about 10 μm or less.

Each of the external electrodes 40 may include an electrically conductive resin layer including, for example, electrically conductive particles and a thermosetting resin. When each of the external electrodes 40 includes an electrically conductive resin layer, the electrically conductive resin layer may cover the fired layer. When the electrically conductive resin layer covers the fired layer, the electrically conductive resin layer is provided between the fired layer and the plated layer. The fired layer corresponds to the first base electrode layer 51 and the second base electrode layer 52. The plated layer corresponds to the first plated layer 71 and the second plated layer 72. The electrically conductive resin layer may completely cover the fired layer. The electrically conductive resin layer may cover a portion of the fired layer.

The electrically conductive resin layer including a thermosetting resin is more flexible than an electrically conductive layer made of a plated film or a fired product of an electrically conductive paste. Therefore, when a physical impact or shock due to thermal cycling is applied to the multilayer ceramic capacitor, the electrically conductive resin layer functions as a buffer layer. Therefore, the electrically conductive resin layer reduces or prevents the occurrence of cracks in the multilayer ceramic capacitor.

Examples of the metal of the electrically conductive particles include silver, copper, nickel, tin, bismuth, or an alloy including at least two of these metals. The electrically conductive particles preferably include, for example, silver. An example of the electrically conductive particles is silver metal powder. Silver has the lowest specific resistance among metals. Silver is suitable in electrode materials. Silver is a noble metal. Silver is unlikely to oxidize. The weatherability of silver is high. For these reasons, silver metal powder is suitable as the electrically conductive particles.

The electrically conductive particles may be, for example, metal powder with a surface coated with silver. When the electrically conductive particles with a surface coated with silver are used, the metal powder is, for example, preferably a powder of copper, nickel, tin, bismuth, or an alloy thereof. In order to make the metal of the base material inexpensive while maintaining the characteristics of silver, it is preferable to use silver-coated metal powder.

The electrically conductive particles may be obtained by, for example, subjecting copper or nickel to an antioxidant treatment. The electrically conductive particles may be, for example, metal powder in which the surface of the metal powder is coated with tin, nickel, or copper. When a metal powder in which the surface of the metal powder is coated with tin, nickel, or copper is used, the metal powder is, for example, preferably silver, copper, nickel, tin, bismuth, or an alloy powder including at least two of these metals.

The shape of the electrically conductive particles is not limited. Examples of the shape of the electrically conductive particles include a spherical shape and a flat shape. It is preferable to use a mixture of the spherical metal powder and the flat metal powder.

The electrically conductive particles included in the electrically conductive resin layer mainly play a role in ensuring the electrical conductivity of the electrically conductive resin layer. When the plurality of conductive particles are in contact with each other, a conduction path is provided inside the electrically conductive resin layer.

Examples of the resin of the electrically conductive resin layer may include at least one of various known thermosetting resins such as an epoxy resin, a phenol resin, a urethane resin, a silicone resin, or a polyimide resin. Among them, one suitable resins is, for example, an epoxy resin. The epoxy resin is excellent in heat resistance, moisture resistance, adhesion, and the like. The resin of the electrically conductive resin layer preferably includes a curing agent together with a thermosetting resin. When an epoxy resin is used as the base resin, the curing agent of the epoxy resin may be various known compounds such as, for example, phenol type, amine type, acid anhydride type, imidazole type, active ester type, or amide imide type.

The electrically conductive resin layer may include a plurality of layers. A preferred thickness of the thickest portion of the electrically conductive resin layer is, for example, about 10 μm or more and 150 μm or less.

The basic configuration of the multilayer ceramic capacitor 1 has been described above. A preferred length in the length direction L of the multilayer ceramic capacitor 1 including the multilayer body 2 and the external electrodes 40 is, for example, about 0.2 mm or more and about 6 mm or less. A preferred length of the multilayer ceramic capacitor 1 in the height direction T is, for example, about 0.05 mm or more and about 5 mm or less. A preferred length of the multilayer ceramic capacitor 1 in the width direction W is, for example, about 0.1 mm or more and about 5 mm or less.

### Segregation of Manganese and Magnesium

In the multilayer ceramic capacitor 1 of the present example embodiment, a large amount of manganese and magnesium is unevenly distributed at the corner portions of the effective layer portion. Hereinafter, descriptions will be provided in order.

### First Region 351 and Second Region 352

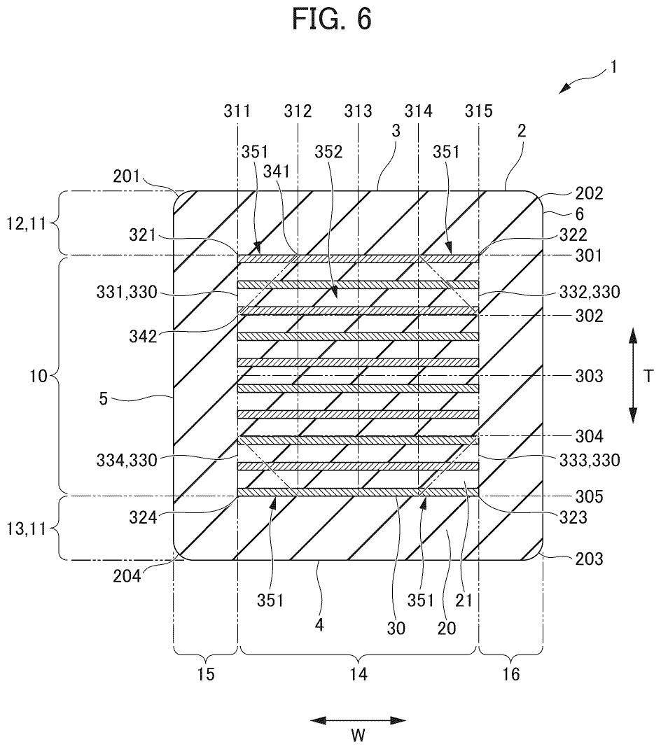

FIG. 6 is a cross-sectional view taken along the line 105-105 of FIG. 2. FIG. 6 shows a WT cross section of the multilayer ceramic capacitor 1. The WT cross section shown in FIG. 6 is a WT cross section at a middle position in the length direction L of the multilayer ceramic capacitor 1. As shown in FIG. 6, the effective layer portion 14 includes first regions 351 and a second region 352 in the WT cross section. Each of the first regions 351 is a region defined by a corresponding one of the four corner portions 330 of the effective layer portion 14. The second region 352 is a region defined as a region of the effective layer portion 14 excluding the first regions 351. The segregation amount of manganese and magnesium in each of the first regions 351 is larger than the segregation amount of manganese and magnesium in the second region 352. The internal electrode layer 30 in each of the first regions 351 includes insulating portions.

### Corner Portion of Effective Layer Portion

Next, the corner portions 330 of the effective layer portion 14 will be described with reference to FIG. 6. In FIG. 6, the line 301 indicates one end of the effective layer portion 14 in the height direction T, and the line 305 indicates the other end of the effective layer portion 14 in the height direction T. A line 302, a line 303, and a line 304 are lines that divide the distance between the line 301 and the line 305 into four equal or substantially equal portions.

In FIG. 6, the line 311 indicates one end of the effective layer portion 14 in the width direction W, and the line 315 indicates the other end of the effective layer portion 14 in the width direction W. A line 312, a line 313, and a line 314 are lines that divide the distance between line 311 and the line 315 into four equal or substantially equal portions.

### Corner Portion of Multilayer Body

Among the four corner portions of the multilayer body 2 described above, a corner portion of a portion where the first main surface 3 and the first lateral surface 5 intersect with each other is referred to as a first corner portion 201 of the multilayer body 2. A corner portion where the first main surface 3 and the second lateral surface 6 intersect with each other is referred to as a second corner portion 202 of the multilayer body 2. A corner portion where the second main surface 4 and the second lateral surface 6 intersect with each other is referred to as a third corner portion 203 of the multilayer body 2. A corner portion where the second main surface 4 and the first lateral surface 5 intersect with each other is referred to as a fourth corner portion 204 of the multilayer body 2.

### Vertex of Effective Layer Portion

When the shape of the effective layer portion 14 in the WT cross section is regarded as a quadrangular shape, four vertices of the quadrangular shape are indicated by points 321 to 324. The vertex 321 is an intersection of the line 301 and the line 311. The vertex 322 is an intersection of the line 301 and the line 315. The vertex 323 is the intersection of the line 305 and the line 315. The vertex 324 is the intersection of the line 305 and the line 311.

The vertex 321 is adjacent to the first corner portion 201 of the multilayer body 2. The vertex 322 is adjacent to the second corner portion 202 of the multilayer body 2. The vertex 323 is adjacent to the third corner portion 203 of the multilayer body 2. The vertex 324 is adjacent to the fourth corner portion 204 of the multilayer body 2.

Each of the corner portions 330 of the effective layer portion 14 is a triangular or substantially triangular portion including one vertex of the effective layer portion 14 in the WT cross section. Each of the corner portions 330 of the effective layer portion 14 includes one vertex of the effective layer portion 14 as one of three vertices of a triangle, each defining the corner portion 330 of the effective layer portion 14.

The corner portion 330 of the effective layer portion 14 including the vertex 321 is referred to as a first corner portion 331 of the effective layer portion 14. The corner portion 330 of the effective layer portion 14 including the vertex 322 is referred to as a second corner portion 332 of the effective layer portion 14. The corner portion 330 of the effective layer portion 14 including the vertex 323 is referred to as a third corner portion 333 of the effective layer portion 14. The corner portion 330 of the effective layer portion 14 including the vertex 324 is referred to as a fourth corner portion 334 of the effective layer portion 14.

The corner portion 330 of the effective layer portion 14 will be described in more detail by taking the first co rner portion 331 of the effective layer portion 14 as an example. The first corner portion 331 of the effective layer portion 14 is a triangular portion having the vertex 321, a point 341 shown in FIG. 6, and a point 342 shown in FIG. 6.

The point 341 is an intersection of the line 301 and the line 312. The position of the point 341 is a position separated from the vertex 321 along one side of the outer side of the effective layer portion 14 by about one-fourth of the length of the side. The one side referred to here is a side parallel or substantially parallel to the width direction W.

The point 342 is an intersection of the line 302 and the line 311. The position of the point 342 is a position separated from the vertex 321 along one side of the outer side of the effective layer portion 14 by about one-fourth of the length of the side. The one side referred to here is a side parallel or substantially parallel to the height direction T.

A triangular or substantially triangular portion provided by connecting the vertex 321, the point 341, and the point 342 corresponds to the first corner portion 331 of the effective layer portion 14. The second corner portion 332 of the effective layer portion 14, the third corner portion 333 of the effective layer portion 14, and the fourth corner portion 334 of the effective layer portion 14 are also defined in the same manner as the first corner portion 331 of the effective layer portion 14.

As described above, each of the corner portions 330 of the effective layer portion 14 refers to a triangular or substantially triangular portion surrounded by connecting the vertex of the effective layer portion 14, a point distant from the vertex of the effective layer portion 14 along one side in a direction of the effective layer portion 14 by about one-fourth of the length of the one side, and a point distant from the vertex of the effective layer portion 14 along another side in another direction of the effective layer portion 14 by about one-fourth of a length of the other side, in the WT cross section.

### First Region

The first regions 351 are collectively referred to as a region in which four corner portions 330 of the effective layer portion 14, that is, the first corner portion 331 of the effective layer portion 14, the second corner portion 332 of the effective layer portion 14, the third corner portion 333 of the effective layer portion 14, and the fourth corner portion 334 of the effective layer portion 14 are combined.

### Second Region

The second region 352 is a region excluding the first region 351 from the effective layer portion 14 in the WT cross section.

The second region 352 is a region excluding, from the effective layer portion 14, a corner portion close to the first corner portion 201 of the multilayer body 2, a corner portion close to the second corner portion 202 of the multilayer body 2, a corner portion close to the third corner portion 203 of the multilayer body 2, and a corner portion close to the fourth corner portion 204 of the multilayer body 2.

### Method for Measuring Segregation Amount

An example of a method for measuring segregation amounts of manganese and magnesium will be described. The segregation amounts of manganese and magnesium are obtained by performing elemental analysis on a cut surface obtained by cutting the multilayer ceramic capacitor 1. The cut surface is a WT cross section at a middle position in the length direction L of the multilayer ceramic capacitor 1. The segregation amount can be measured by, for example, elemental analysis using wavelength dispersive X-ray analysis (WDX) or transmission electron microscope-energy dispersive X-ray analysis (TEM-EDX). At this time, in each of the first corner portion 331 to the fourth corner portion 334, the element concentration in each of the five segregation regions is measured, and the average value thereof is set as the segregation amount.

### Measurement Result of Segregation Amount

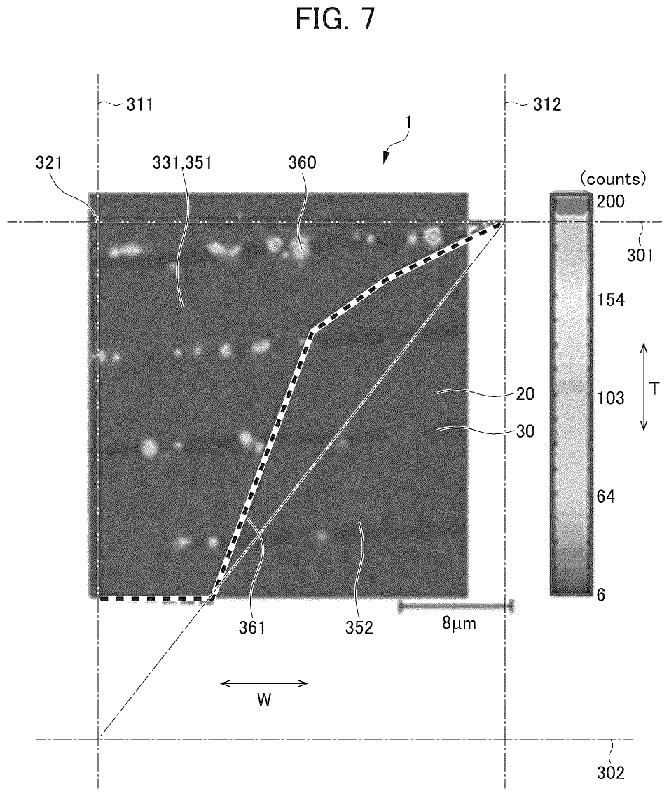

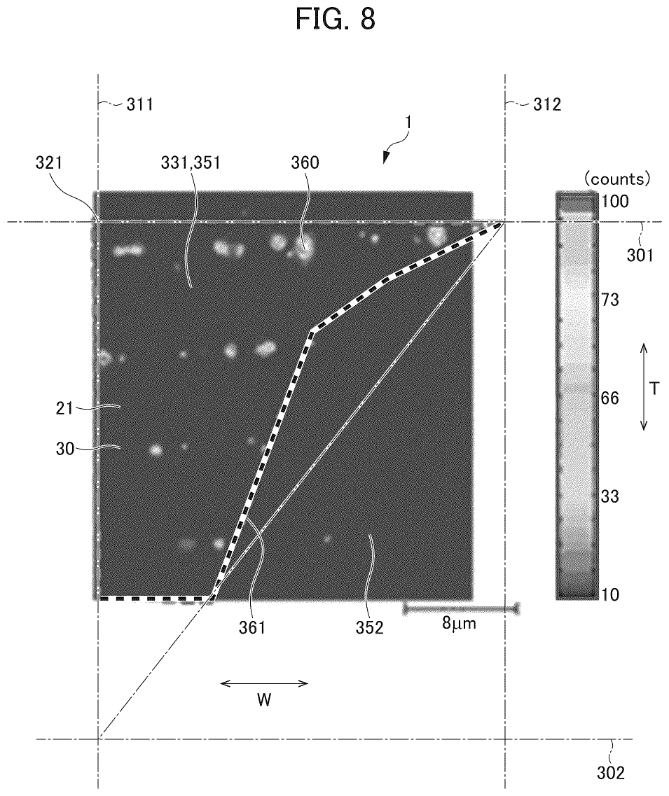

With reference to FIGS. 7 and 8, the results of elemental analysis of the multilayer ceramic capacitor 1 of the present example embodiment in the WT cross section will be described. FIGS. 7 and 8 are graphs showing the results of elemental analysis in the WT cross section of the multilayer ceramic capacitor 1 of the present example embodiment. FIGS. 7 and 8 both show transmission electron microscope-energy dispersive X-ray analysis images. The multilayer ceramic capacitor 1 showing the results of elemental analysis in FIG. 7 and the multilayer ceramic capacitor 1 showing the results of elemental analysis in FIG. 8 are the same samples.

In FIGS. 7 and 8, the first corner portion 331 of the effective layer portion 14 is shown as an example of the first region 351. However, FIG. 7 and FIG. 8 show a portion of the first corner portion 331 of the effective layer portion 14 instead of the entirety thereof. In addition, FIGS. 7 and 8 show a portion of the effective layer portion 14 adjacent to the first corner portion 331 as a portion of the second region 352.

In FIG. 7, a light-colored point 360 indicates segregation of manganese, and in FIG. 8, a light-colored point 360 indicates segregation of magnesium. The frame 361 shown in FIG. 7 indicates a range in which a large amount of segregation of manganese is observed, and the frame 361 shown in FIG. 8 indicates a range in which a large amount of segregation of magnesium is observed. It can be seen that a large amount of manganese and magnesium segregate not in the second region 352, but in the first region 351.

As described above, in the multilayer ceramic capacitor 1 of the present example embodiment, the segregation amounts of manganese and magnesium in the first region 351 are larger than the segregation amounts of manganese and magnesium in the second region 352.

As shown in FIGS. 7 and 8, a large amount of manganese or magnesium is present on the lines of the internal electrode layers 30 in the WT cross section. Manganese or magnesium is segregated in depletion, which is portions where the internal electrode layer 30 is missing. When depletion exists in the internal electrode layers 30 and manganese or magnesium is segregated in the depletion, the resistivity of the internal electrode layer 30 decreases.

As shown in FIGS. 7 and 8, a large amount of manganese and magnesium are segregated in the internal electrode layers 30 of the first region 351. Therefore, the resistivity of the first region 351 is higher than the resistivity of the second region 352. The internal electrode layer 30 in the first region 351 includes insulating portions.

In the multilayer ceramic capacitor 1 of the present example embodiment, as described above, the segregation amounts of manganese and magnesium in the first region 351 are larger than the segregation amounts of manganese and magnesium in the second region 352.

In particular, segregation of manganese and magnesium is concentrated in the internal electrode layers 30 of the first region 351. As a result, the internal electrode layers 30 in the first region 351 include insulating portions.

As described above, in the multilayer ceramic capacitor 1 of the present example embodiment, manganese and magnesium are concentrated and segregated in the internal electrode layers 30 at each of the corner portions 330 of the effective layer portion 14, such that the insulating portions are provided in the internal electrode layers 30 at each of the corner portions 330 of the effective layer portion 14. In the multilayer ceramic capacitor 1 of the present example embodiment, it is possible to improve the high-temperature reliability by enabling each of the corner portions 330 of the effective layer portion 14, which are likely to cause a decrease in the high-temperature load reliability, to have insulating properties.

For example, in the first region 351, the segregation amount of manganese is preferably about 5 mol % or more and about 10 mol % or less, and the segregation amount of magnesium is preferably about 5 mol % or more and about 10 mol % or less. By setting the segregation amount of manganese and the segregation amount of magnesium to fall within the above-described ranges, it is possible to efficiently provide the insulating portions by the internal electrode layers of the corner portion 330 of the effective layer portion 14. As a result, it is possible to further improve the high-temperature reliability of the multilayer ceramic capacitor 1.

When the segregation amount of manganese or the segregation amount of magnesium in the first region 351 is less than about 5 mol %, insulation of each of the corner portions 330 of the effective layer portion 14 is insufficient. When the segregation amount of manganese or the segregation amount of magnesium in the first region 351 is greater than about 10 mol %, the range of the insulating portions extends to a region other than each of the corner portions 330 of the effective layer portion 14. As a result, capacitance of the multilayer ceramic capacitor 1 decreases.

### EXAMPLES

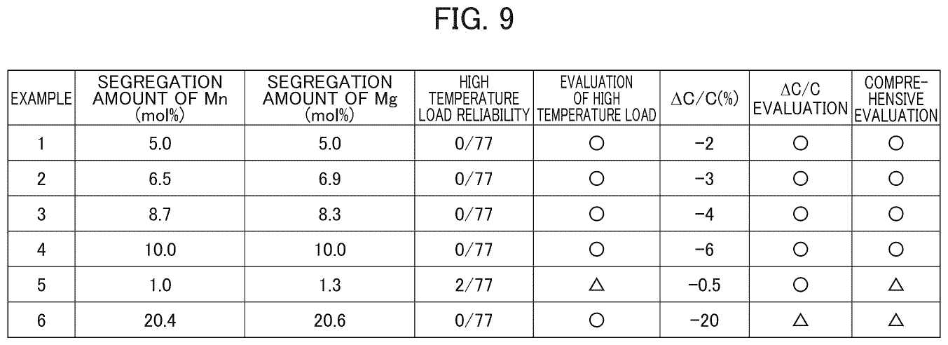

Examples of a multilayer ceramic capacitor 1 according to example embodiments of the present invention will be described with reference to FIG. 9. FIG. 9 is a table showing Examples of the multilayer ceramic capacitors of example embodiments. Samples, evaluation items, evaluation conditions, and the like of the Examples are as follows. Samples whose production conditions were adjusted so as to have different amounts of segregation according to a production method described later were produced in lot units as the samples of Examples 1 to 6. The samples in each lot were manufactured under the same or substantially the same manufacturing conditions. For each of the Examples, n=3 samples for segregation amount measurement, n=5 samples for capacitance evaluation, and n=77 samples for high temperature load reliability evaluation were taken from the same lot and prepared. In the measurement of the segregation amount and the evaluation of the capacitance, the evaluation was performed using the measurement results and the average value of the evaluation results.

### Samples

Dimensions of a multilayer ceramic capacitor: about 3.15 mm in length direction L, about 1.65 mm in width direction W, and about 1.65 mm in height direction T

Main material for dielectric layer: barium titanate

Capacitance: about 0.01 μF

Material of internal electrode layer: nickel

### Evaluation of High Temperature Load Reliability

Applied voltage: about 756 V (×1.2W. V.), about 125° C., about 2000 hrs. Number of samples: 77

Evaluation Criteria: ◯ (circle symbol indicating good) indicates a defective number of samples of 0, and Δ (triangle symbol indicating fair) indicates a defective number of samples of 1 or more and 2 or less.

Evaluation of Capacitance (ΔC/C) (Δ in “ΔC/C” indicates delta indicating change or difference)

Device for measuring capacitance C: LCR meter

ΔC/C=(Capacitance in a case where magnesium and manganese are added to (segregated in) the corner portion of the effective layer portion-Capacitance in a case where magnesium and manganese are not added to (not segregated in) the corner portion of the effective layer portion)/(Capacitance in a case where magnesium and manganese are not added (not segregated in)×100 (%)

Evaluation Criteria: ◯ (circle symbol indicating good) indicates that ΔC/C is −10 (%) or more, and A (triangle symbol indicating fair) indicates that AC/C is less tha p31 10 (%) and −30 (%) or more.

### Comprehensive Evaluation

Evaluation Criteria: ◯ (circle symbol indicating good) and Δ (triangle symbol indicating fair)

As shown in FIG. 9, in all of the Examples, the evaluation of the high-temperature load reliability was evaluated as ◯ (circle symbol indicating good) and A (triangle symbol indicating fair). In Example 5 in which the segregation amount of manganese in the region in which segregation was observed in the first region 351 was less than about 5 mol % and the segregation amount of magnesium in the region in which segregation was observed in the first region 351 was less than about 5 mol %, the evaluation of the high temperature load reliability was determined as Δ (triangle symbol indicating fair). Further, in Example 6 in which the segregation amount of manganese in the region where segregation was observed in the first region 351 exceeded about 10 mol % and the segregation amount of magnesium in the region where segregation was observed in the first region 351 exceeded about 10 mol %, ΔC/C was about −20%. Therefore, the evaluation of the capacitance (ΔC/C) in Example 6 was determined as A (triangle symbol indicating fair).

Based on the results of the evaluation of the high-temperature load reliability and the evaluation of the capacitance (ΔC/C), the comprehensive evaluation of Examples 1 to 4 was determined as ◯ (circle symbol indicating good), and the comprehensive evaluation of Examples 5 and 6 was determined as A (triangle symbol indicating fair).

### Method for Manufacturing Multilayer Ceramic Capacitor

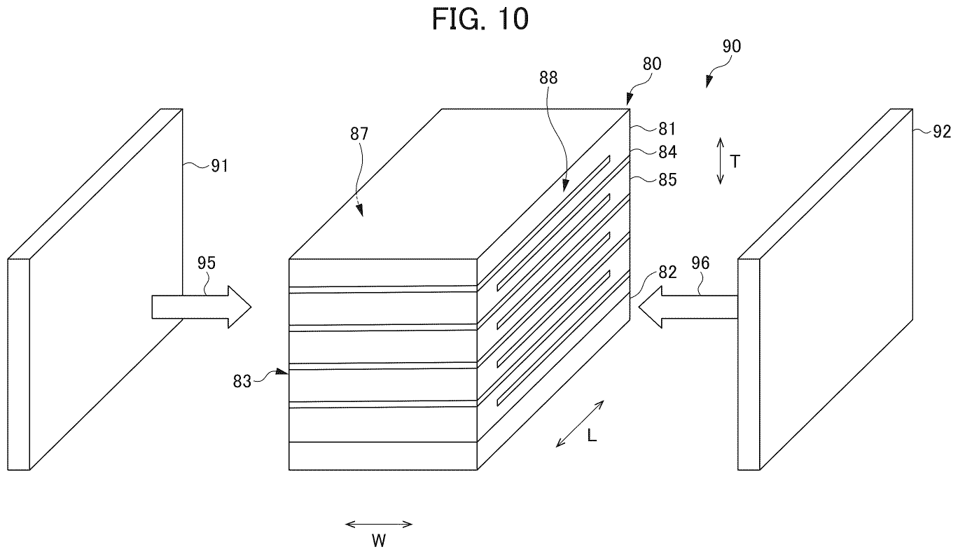

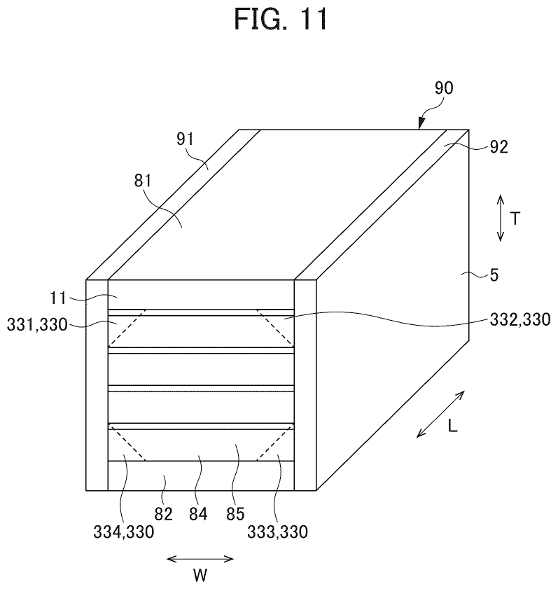

An example of a method of manufacturing the multilayer ceramic capacitor 1 according to an example embodiment of the present invention will be described with reference to FIGS. 10 and 11. FIG. 10 is a view showing a side gap base body 80, a first side gap sheet 91, and a second side gap sheet 92. FIG. 11 is a view showing a multilayer chip 90 in which the first side gap sheet 91 and the second side gap sheet 92 are laminated on the side gap base body 80. In FIGS. 10 and 11, portions relating to the internal electrode layers are particularly simplified. The method of manufacturing the multilayer ceramic capacitor 1 is not limited to the following method.

In the method of manufacturing the multilayer ceramic capacitor 1 of the present example embodiment, the multilayer body 2 is formed using the first side gap sheet 91 and the second side gap sheet 92 in order to segregate manganese and magnesium at each of the corner portions 330 of the effective layer portion 14 and to form the first region 351 as insulating layers.

### Correspondence between Multilayer Body and Multilayer Chip

In the following description, the multilayer body 2 before being fired is referred to as a multilayer chip 90. In the multilayer chip 90, a portion corresponding to the first lateral surface-side outer layer portion 15 after firing is referred to as a first side gap sheet 91, and a portion corresponding to the second lateral surface-side outer layer portion 16 after firing is referred to as a second side gap sheet 92. Further, in the multilayer chip 90, a portion other than the first side gap sheet 91 and the second side gap sheet 92 is referred to as a side gap base body 80.

In addition, in the side gap base body 80, a portion corresponding to the first main surface-side outer layer portion 12 after firing is referred to as a first base body outer layer 81, and a portion corresponding to the second main surface-side outer layer portion 13 after firing is referred to as a second base body outer layer 82. In the side gap base body 80, a portion other than the first base body outer layer 81 and the second base body outer layer 82 is referred to as a base body inner layer 83. A portion of the base body inner layer 83 functions as the effective layer portion 14 after firing.

### Side Gap Base Body

First, dielectric sheets for manufacturing the first base body outer layer 81, the second base body outer layer 82, and the base body inner layer 83 are prepared. In addition, an electrically conductive paste for manufacturing the base body inner layer 83 is prepared. The dielectric sheets define and function as the dielectric layers 20 in the multilayer body 2. The electrically conductive paste defines and functions as the internal electrode layers 30 in the multilayer body 2. Both of the dielectric sheet and the electrically conductive paste include a binder and a solvent. The binder and the solvent may be known. The electrically conductive paste includes a metal powder, an organic binder, and an organic solvent.

An electrically conductive paste for manufacturing the internal electrode layers 30 is printed on the dielectric sheets for manufacturing the base body inner layer 83 by using a printing plate which is pattern-designed for the electrically conductive paste to have the shape of the internal electrode layer 30. Examples of printing methods include screen printing and gravure printing. Thus, the dielectric sheets on which the pattern of the first internal electrode layer 31 is formed and the dielectric sheets on which the pattern of the second internal electrode layer 32 is formed are prepared.

By laminating a predetermined number of dielectric sheets for manufacturing the first base body outer layer 81 on which the pattern of the internal electrode layer 30 is not printed, a portion defining and functioning as the first main surface-side outer layer portion 12 is formed. The dielectric sheets for manufacturing the base body inner layer 83 on which the pattern of the first internal electrode layer 31 is printed and the dielectric sheets for manufacturing the base body inner layer 83 on which the pattern of the second internal electrode layer 32 is printed are sequentially and alternately laminated thereon. Thus, the base body inner layer 83 in which the dielectric sheets 84 for manufacturing the base body inner layer 83 and the electrically conductive paste 85 printed on the dielectric sheets 84 are alternately laminated is formed.

A portion defining and functioning as the second main surface-side outer layer portion 13 is further laminated thereon. This portion is formed by laminating a predetermined number of dielectric sheets for the second base body outer layer 82 on which the pattern of the internal electrode layer 30 is not printed. The side gap base body 80 is thus obtained.

### Side Gap Sheet

The first side gap sheet 91 is obtained by laminating a predetermined number of dielectric sheets for manufacturing the first side gap sheet 91 on which the electrically conductive paste is not printed. Similarly, the second side gap sheet 92 is obtained.

Next, as indicated by the arrow 95 in FIG. 10, the first side gap sheet 91 is laminated on the first LT surface 87 of the side gap base body 80. Similarly, as indicated by the arrow 96, the second side gap sheet 92 is laminated on the second LT surface 88 of the side gap base body 80. The multilayer chip 90 is thereby obtained.

FIG. 11 shows a multilayer chip 90. As shown in FIG. 11, the portions corresponding to the first corner portion 331, the second corner portion 332, the third corner portion 333, and the fourth corner portion 334 are partially surrounded by the dielectric sheet for manufacturing the outer layer and the dielectric sheet for manufacturing the side gap sheet.

### Addition of Magnesium and Manganese to Dielectric Sheet

Segregation of manganese and magnesium in each of the corner portions 330 of the effective layer portion 14 and formation of insulating layers in each of the corner portions 330 can be performed by causing magnesium and manganese to be segregated in each of the corner portions 330 of the effective layer portion 14 from the dielectric sheets for manufacturing the first base body outer layer 81, the dielectric sheets for manufacturing the second base body outer layer 82, the dielectric sheets for manufacturing the first side gap sheet 91, and the dielectric sheets for manufacturing the second side gap sheet 92. Therefore, in addition to the dielectric sheets for manufacturing the base body inner layer 83, magnesium and manganese are included in the dielectric sheets for manufacturing the first base body outer layer 81, the dielectric sheets for manufacturing the second base body outer layer 82, the dielectric sheets for manufacturing the first side gap sheet 91, the and dielectric sheets for manufacturing the second side gap sheet 92 in an amount of about 3 mol % or more and about 5 mol % or less, respectively. With such a configuration, it is possible to increase the concentration of magnesium and manganese in each of the corner portions 330 of the effective layer portion 14 as compared with other portions.

As described above, each of the corner portions 330 of the effective layer portion 14 is close to the dielectric sheets for manufacturing the outer layer and the dielectric sheets for manufacturing the side gap sheet. Therefore, each of the corner portions 330 of the effective layer portion 14 is likely to receive migration of magnesium and manganese included in the dielectric sheets for manufacturing the outer layer and the dielectric sheets for manufacturing the side gap sheet. Therefore, it is possible to easily increase the concentration of magnesium and manganese in each of the corner portions 330 of the effective layer portion 14.

Next, the multilayer chip is fired to obtain the multilayer body 2. Before firing, if necessary, the multilayer chip may be pressed, or the multilayer chip may be polished by, for example, barrel polishing or the like to round the corner portions or the ridge portions. The firing temperature depends on the materials of the dielectric layers 20 and the internal electrode layers 30, but is preferably, for example, about 900° C. or more and about 1400° C. or less.

An electrically conductive paste defining and functioning as the base electrode layer 50 is applied to both end surfaces of the multilayer body 2. In the present example embodiment, the base electrode layer 50 is a fired layer. The fired layer is formed by applying an electrically conductive paste including a glass component and a metal to the multilayer body 2 by a method such as, for example, dipping, and then performing a firing treatment. The temperature of the firing treatment at this time is, for example, preferably about 700° C. or more and about 900° C. or less.

The multilayer chip before firing and the electrically conductive paste applied to the multilayer chip may be fired at the same time. In this case, the fired layer is preferably formed by firing a material to which a ceramic material is added instead of a glass component. At this time, as the ceramic material to be added, it is preferable to use the same type of ceramic material as the dielectric layer 20. In this case, an electrically conductive paste is applied to the multilayer chip before firing, and the multilayer chip and the electrically conductive paste applied to the multilayer chip are simultaneously fired to form the multilayer body 2 in which the fired layer is formed.

Thereafter, a plated layer is formed on the surface of the base electrode layer 50 including the fired layer. In the present example embodiment, the first plated layer 71 is formed on the surface of the first base electrode layer 51. A second plated layer 72 is formed on the surface of the second base electrode layer 52. In the present example embodiment, for example, a nickel plated layer and a tin plated layer formed as the plated layer. When plating is performed, for example, either electrolytic plating or electroless plating may be used. However, electroless plating requires pretreatment with a catalyst or the like in order to improve the plating deposition rate, and thus has a disadvantage in that the process becomes complicated. Therefore, in general, electrolytic plating is preferably used. The nickel plated layer and the tin plated layer are sequentially formed by barrel plating, for example.

When the electrically conductive resin layer is provided, the electrically conductive resin layer may be provided so as to cover the fired layer. When the electrically conductive resin layer is provided, an electrically conductive resin paste including a thermosetting resin and a metal component is applied onto the fired layer, and then heat treatment is performed at a temperature of, for example, about 250° C. to about 550° C. or more. The thermosetting resin is thus thermally cured to form the electrically conductive resin layer. The atmosphere during this heat treatment is, for example, preferably a nitrogen atmosphere. In order to prevent scattering of the resin and oxidation of various metal components, the oxygen concentration is, for example, preferably about 100 ppm or less.

Through the above manufacturing steps, the multilayer ceramic capacitor 1 is manufactured.

As described above, in multilayer ceramic capacitors 1 according to example embodiments of the present invention, by concentrating the segregation of manganese and magnesium in the internal electrode layers 30 in each of the corner portions 330 of the effective layer portion 14, it is possible to enable each of the corner portions 330, which are vulnerable as weak points in terms of high-temperature load reliability, to include insulating layers, such that it is possible to improve high-temperature reliability. With such a configuration, in multilayer ceramic capacitors 1 according to example embodiments, it is possible to reduce or prevent a decline in high-temperature load reliability starting from the reduced thickness portion due to the thickness of the dielectric layers and the thickness of the internal electrode layers in the vicinity of the corner portion of the multilayer ceramic capacitor being likely to be reduced.

The present invention is not limited to configurations of the above-described example embodiments, and can be appropriately modified and applied without changing the scope of the present invention. Combinations of two or more of the individual desirable configurations described in the above example embodiments are also included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers and a plurality of internal electrode layers that are laminated, a first main surface and a second main surface opposed to each other in a height direction, a first lateral surface and a second lateral surface opposed to each other in a width direction orthogonal or substantially orthogonal to the height direction, a first end surface and a second end surface opposed to each other in a length direction orthogonal or substantially orthogonal to the height direction and the width direction, an effective layer portion in which the plurality of dielectric layers and the plurality of internal electrode layers are alternately laminated, and outer layer portions sandwiching the effective layer portion by a corresponding one of the outer layer portions adjacent to the first main surface and a corresponding one of the outer layer portions adjacent to the second main surface;
a first external electrode on the first end surface; and
a second external electrode on the second end surface;
wherein
in a cross section of the multilayer body in a plane parallel or substantially parallel to the width direction and the height direction, the effective layer portion includes a first region defined by four corner portions of the effective layer portion and a second region defined as a region of the effective layer portion excluding the first region;
segregation amounts of manganese and magnesium in the first region are larger than segregation amounts of manganese and magnesium in the second region; and
portions of the plurality of internal electrode layers in the first region include insulating portions.

2. The multilayer ceramic capacitor according to claim 1, wherein, in the insulating portions of the first region, a segregation amount of manganese is about 5 mol % or more and about 10 mol % or less, and a segregation amount of magnesium is about 5 mol % or more and about 10 mol % or less.

3. The multilayer ceramic capacitor according to claim 1, wherein
a dimension of the multilayer body in the length direction is about 0.2 mm or more and about 6 mm or less;
a dimension of the multilayer body in the height direction is about 0.05 mm or more and about 5 mm or less; and
a dimension of the multilayer body in the width direction is about 0.1 mm or more and about 5 mm or less.

4. The multilayer ceramic capacitor according to claim 1, wherein each of the plurality of dielectric layers includes barium titanate, calcium titanate, strontium titanate or calcium zirconate as a main component.

5. The multilayer ceramic capacitor according to claim 4, wherein each of the plurality of dielectric layers includes a manganese compound, an iron compound, a copper compound, a cobalt compound, or a nickel compound as a subcomponent.

6. The multilayer ceramic capacitor according to claim 1, wherein a thickness of each of the plurality of dielectric layers is about 0.2 μm or more and about 10 μm or less. ceramic capacitor according to claim 1, wherein a number of the plurality of dielectric layers is 15 or more and 1200 or less.

8. The multilayer ceramic capacitor according to claim 1, wherein each of the internal electrode layers includes a counter portion opposed to an adjacent one of the plurality of internal electrode layers, and an extension portion extending from the counter portion to a respective one of the first and second end surfaces.

9. The multilayer ceramic capacitor according to claim 1, wherein each of the plurality of internal electrode layers includes nickel, copper, silver, palladium, or gold, or alloys including at least one of nickel, copper, silver, palladium, or gold.

10. The multilayer ceramic capacitor according to claim 1, wherein a thickness of each of the plurality of internal electrode layers is about 0.2 μm or more and about 2.0 μm or less.

11. The multilayer ceramic capacitor according to claim 1, wherein a number of the plurality of internal electrode layers is 15 or more and 1000 or less.

12. The multilayer ceramic capacitor according to claim 1, wherein the multilayer body includes an inner layer portion including the plurality of internal electrode layers and some of the plurality of dielectric layers, and outer layer portions sandwiching the inner layer portion in the height direction.

13. The multilayer ceramic capacitor according to claim 1, wherein each of the first and second external electrodes includes a base electrode layer and a plated layer on the base electrode layer.

14. The multilayer ceramic capacitor according to claim 13, wherein the base electrode layer extends to a portion of the first main surface, a portion of the second main surface, a portion of the first lateral surface, and a portion of the second lateral surface.

15. The multilayer ceramic capacitor according to claim 13, wherein the base electrode layer includes a fired layer.

16. The multilayer ceramic capacitor according to claim 15, wherein the fired layer includes a metal component and at least one of a glass component or a ceramic component.

17. The multilayer ceramic capacitor according to claim 16, wherein the metal component includes at least one of copper, nickel, silver, palladium, an alloy of silver and palladium, or gold.

18. The multilayer ceramic capacitor according to claim 16, wherein the glass component includes at least one of boron, silicon, barium, magnesium, aluminum, or lithium.

19. The multilayer ceramic capacitor according to claim 16, wherein the ceramic component includes at least one of barium titanate, calcium titanate, a mixed crystal material in which a portion of the barium in barium titanate is substituted with calcium, strontium titanate, or calcium zirconate.

20. The multilayer ceramic capacitor according to claim 13, wherein a thickness of the base electrode layer is about 10 μm or more and about 200 μm or less in a middle portion in the height direction and the width direction of the base electrode layer.
